(19) United States
(12) Patent Application Publication
(10) Pub. No.: US 2005/0162806 A1
(43) Pub. Date: Jul. 28, 2005

(54) Thermal plastic deformation of RF MEMS devices

(75) Inventors: Neil Sarkar, Richardson, TX (US); Aaron Geisberger, Dallas, TX (US)

Correspondence Address: HAYNES AND BOONE, LLP, 901 MAIN STREET, SUITE 3100, DALLAS, TX, 75202, US

(73) Assignee: Zyvex Corporation, Richardson, TX (US)

(21) Appl. No.: 10/850,904

(22) Filed: May 20, 2004

Related U.S. Application Data
(63) Continuation-in-part of application No. 10/762,848, filed on Jan. 22, 2004.

(51) Int. Cl. H01G 7/00

(52) U.S. Cl. 361/277

(57) ABSTRACT

A method of manufacturing an RF device including, in one embodiment, forming a deformable conductor over a substrate and plastically deforming the conductor via exposure to thermal energy to tune an electrical characteristic of the RF device. In another embodiment, the deformable conductor may also be elastically deformed to tune the electrical characteristic.

### CROSS-REFERENCE

This application is a continuation-in-part of U.S. patent application Ser. No. 10/762,848 entitled “MEMS DEVICE HAVING COMPACT ACTUATOR” filed on Jan. 22, 2004, which is hereby incorporated by reference in its entirety.

### BACKGROUND

Radio frequency (RF) devices are commonly used in communication systems where high frequency operation is required. For example, RF switches now promise high-speed mechanical switching for use in RF communication systems.

Microelectromechanical systems (MEMS) are miniature devices that are being manufactured in a wide variety of mechanical forms. MEMS devices are inherently both mechanical and electrical devices that are reliable when designed for minimal wear and exposure to contamination. Electrical functionality is often determined by the mechanical geometry of the MEMS devices. RF MEMS switches offer high frequency operation for RF communication systems but offer limited witching speeds due to limitations inherent in mechanical systems.

RF front-end circuitry has remained heavily dependent on large discrete passive components, like inductors. Inductors play a key role in resonators for low phase-noise, voltage-controlled oscillators, and as filter components and reactive impedance-matching elements. Variable inductors can provide performance optimization and added functionality. For these applications, inductors must be accurate, and operate with low losses, low power consumption, and high linearity. Inductors with a quality factor (Q) greater than 15, a self-resonance frequency above 10 GHz, and accuracy better than ±2% are generally desired for RF integrated circuit applications, while even a small degree of continuous inductance variation can be useful for finely tuning the frequency of resonant circuits, or accurately matching impedances. Unfortunately, planar inductors integrated directly with RF integrated circuit technology are subject to extreme parasitic losses resulting from the large flat geometry coupling to the low resistivity substrate. Loss reduction techniques such as local substrate removal can help, but not without imposing fabrication and compatibility issues. Similar advantages are offered by MEMS implementations of tunable RF capacitors and filter circuits.

### BRIEF DESCRIPTION OF THE DRAWINGS

Aspects of the present disclosure are best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1A illustrates a sectional view of one embodiment of a MEMS device constructed according to aspects of the present disclosure.

FIG. 1B illustrates a sectional view of another embodiment of a MEMS device during an intermediate stage of manufacture according to aspects of the present disclosure.

FIG. 1C illustrates a sectional view of the MEMS device shown in FIG. 1B in a subsequent stage of manufacture according to aspects of the present disclosure.

FIG. 2 illustrates a perspective view of a portion of one embodiment of a MEMS actuator constructed according to aspects of the present disclosure.

FIG. 3 illustrates a perspective view of a portion of another embodiment of a MEMS actuator constructed according to aspects of the present disclosure.

FIG. 4 illustrates a perspective view of a portion of another embodiment of a MEMS actuator constructed according to aspects of the present disclosure.

FIG. 5 illustrates a perspective view of a portion of one embodiment of an actuated MEMS device constructed according to aspects of the present disclosure.

FIG. 6 illustrates a perspective view of another embodiment of an actuated MEMS device constructed according to aspects of the present disclosure.

FIG. 7 illustrates a perspective view of another embodiment of an actuated MEMS device constructed according to aspects of the present disclosure.

FIG. 8 illustrates a perspective view of another embodiment of an actuated MEMS device constructed according to aspects of the present disclosure.

FIG. 9 illustrates a perspective view of another embodiment of an actuated MEMS device constructed according to aspects of the present disclosure.

FIG. 10 illustrates a perspective view of another embodiment of an actuated MEMS device constructed according to aspects of the present disclosure.

FIGS. 11-15 illustrate block diagrams of various embodiments of methods of tuning a device according to aspects of the present disclosure.

FIG. 16 illustrates a schematic of one embodiment of a tuning circuit according to aspects of the present disclosure.

FIG. 17 illustrates a perspective view of one embodiment of a tunable coupling device according to aspects of the present disclosure.

FIG. 18a illustrates a top view of one embodiment of a portion of an inductive device in an intermediate stage of manufacture according to aspects of the present disclosure.

FIG. 18b illustrates a perspective view of the inductive device shown in FIG. 18a in a subsequent stage of manufacture.

FIGS. 19A-E illustrate sectional views of a microelectronic device during various stages of manufacture according to aspects of the present disclosure.

FIG. 20 illustrates a perspective view of a portion of another embodiment of a microelectronic device according to aspects of the present disclosure.

FIG. 21 illustrates a perspective view of a portion of another embodiment of a microelectronic device according to aspects of the present disclosure.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed. Moreover, the formation of a first feature over, on or coupled to a second feature in the description that follows may include embodiments in which the first and second features are in direct contact, and may also include embodiments in which additional features interpose the first and second features, such that the first and second features may not be in direct contact.

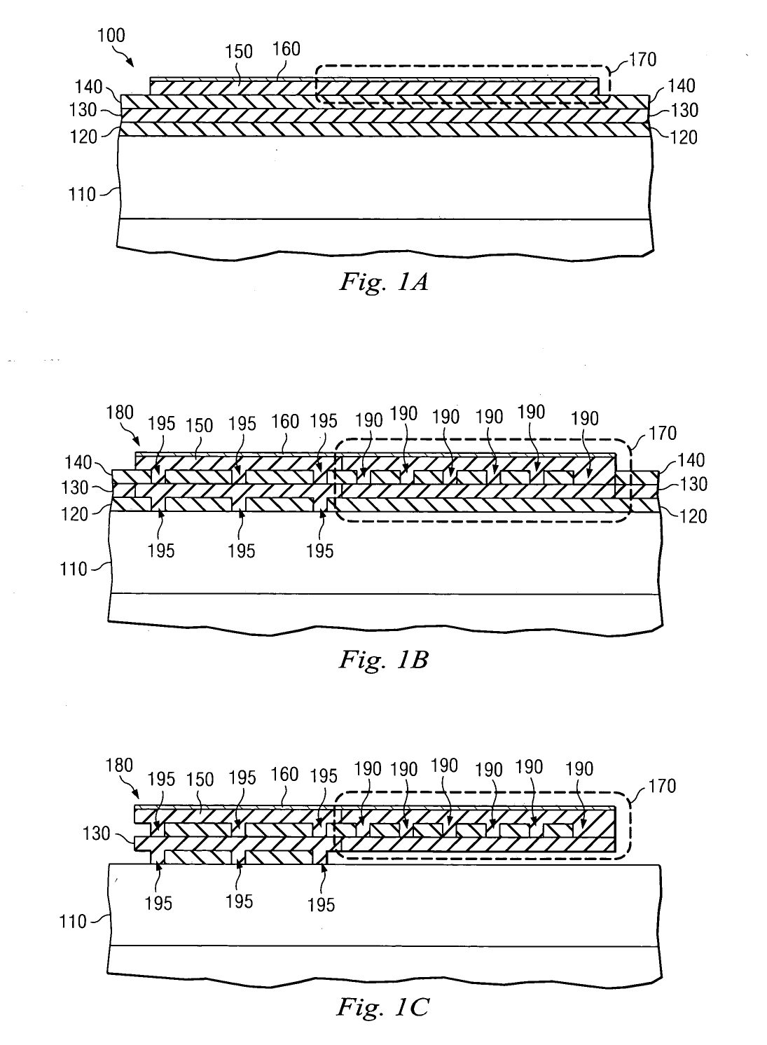

Referring to FIG. 1, illustrated is a sectional view of one embodiment of a MEMS device 100 constructed according to aspects of the present disclosure. In one embodiment, the MEMS device 110 may have feature dimensions (e.g., patterned line widths) that are less than about 50 microns. In another embodiment, the feature dimensions may be less than about 25 microns. The MEMS device 110 may also be a NEMS device, such as those having feature dimensions less than about 1000 nm. Accordingly, descriptions herein pertaining to MEMS devices are applicable and/or readily adaptable to NEMS devices, such that embodiments herein regarding MEMS devices also contemplate NEMS devices.

The MEMS device 100 may include or be formed on or over a substrate 110, which may comprise a bottom-most layer or region of the device 100 or a component of another device to which the MEMS device 100 may be bonded or otherwise coupled. The substrate 110 may comprise at least a portion of a silicon-on-insulator (SOI) substrate.

In the illustrated embodiment, the MEMS device 100 is defined from a stack of layers over the substrate 110 successively including a sacrificial layer 120, an actuator layer 130, a sacrificial layer 140, and additional actuator layers 150 and 160. In one embodiment, the sacrificial layers 120, 140 comprise silicon dioxide, the actuator layers 130 and 150 comprise polysilicon, and the actuator layer 160 comprises gold and/or another metal or metal alloy. Each of the layers 120-160 may be formed by conventional or future-developed processes, and may have individual thicknesses ranging between about 100 nm and about 10,000 nm. The layers 120-160 may also have other thicknesses and comprise other materials within the scope of the present disclosure. An actuator 170 may be etched, patterned, or otherwise defined from the actuator layers 150 and 160, as indicated in FIG. 1. However, the actuator 170 may also be defined from the actuator layers 130, 150, and 160, or from additional and/or alternative layers. The layers from which the actuator 170 is defined may not have common coefficients of thermal expansion, such that the actuator 170 (and similar examples described below) may be a bimorph actuator.

The actuator layer 150 may comprise a first material having a first coefficient of thermal expansion and the actuator layer 160 may comprise a second material having a second coefficient of thermal expansion, wherein the first and second coefficients of thermal expansion are different. For example, the first coefficient of thermal expansion may be greater than or less than the second coefficient of thermal expansion. In one embodiment, the first coefficient of thermal expansion may be about 3.0 ppm/deg and the second coefficient of thermal expansion may be about 14.0 ppm/deg. In another embodiment, the first coefficient of thermal expansion may be at least about 450% less than the second coefficient of thermal expansion. The actuator layer 150 may also comprise a material having a different coefficient of thermal expansion than the actuator layer 130.

Referring to FIG. 1B, illustrated is a sectional view of another embodiment of a MEMS device 180 constructed according to aspects of the present disclosure. The MEMS device 180 may be substantially similar to the MEMS device 100 shown in FIG. 1A. However, the MEMS device 180 may employ the actuator layer 130 to reinforce the actuator 170 or to provide multidirectional current paths, as in embodiments described below. For example, vias or other openings 190 (hereafter collectively referred to as vias) may be etched or otherwise patterned in the sacrificial layer 140 prior to depositing the actuator layer 150 over the sacrificial layer 140. When the actuator layer 150 is subsequently formed over the sacrificial layer 140, the vias 510 are substantially filled with the material forming the actuator layer 150.

Referring to FIG. 1C, illustrated is a sectional view of the MEMS device 180 shown in FIG. 1B after undergoing a release process. During the release process, all or a portion of the MEMS device 180 may be dip-etched in hydrofluoric acid or another etching chemistry to substantially remove the sacrificial layers 120, 140. Consequently, the actuator 170 may comprise portions of the actuator layer 130 in addition to portions of the actuator layers 150, 160. As similarly described above, the actuator layers 130, 150, 160 may have varying coefficients of thermal expansion, such that the actuator 170 may be a bimorph actuator. As also shown in FIGS. 1B and 1C, additional vias 195 may be formed to anchor the MEMS device 180 to the substrate 110. Moreover, the released position of the actuator 170 is not limited to the orientation shown in FIG. 1C. For example, inherent stresses may accumulate during the fabrication of the actuator 170 prior to the release process, such that upon the completion of the release process the actuator 170 may be skewed away or towards the substrate 110.

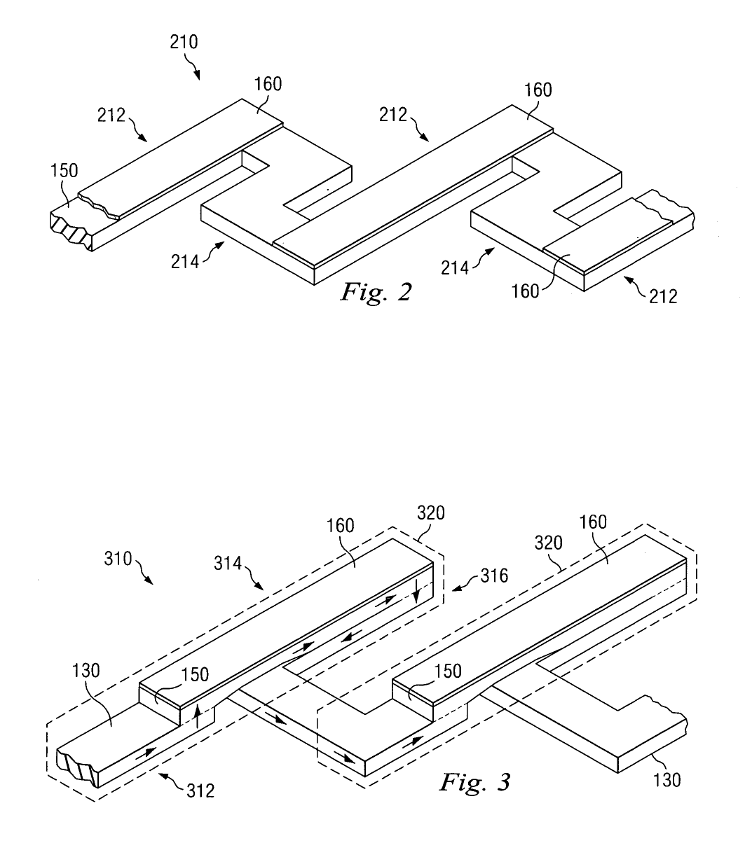

Referring to FIG. 2 with continued reference to FIG. 1A, illustrated is a perspective of a portion of one embodiment of an actuator 210 constructed according to aspects of the present disclosure. The actuator 210 may be similar in composition and manufacture to the actuator 170 shown in FIG. 1A. The actuator 210 may be defined from the first and second actuator layers 150, 160 of FIG. 1A, such as by etching or otherwise patterning. For example, in the embodiment shown in FIG. 2, the actuator 210 has a substantially serpentine shape. However, only portions of the actuator 210 may be defined from both of the actuator layers 150, 160. That is, the actuator 170 may comprise a plurality of deformable segments 212 coupled end-to-end by interposing static segments 214, wherein the deformable segments 212 include portions of the actuator layers 150, 160, and the static segments 214 include portions of the actuator layer 150 but not of the actuator layer 160.

The deformable segments 212 and/or the static segments 214 may be rectilinear, curvilinear, or otherwise patterned as necessary for interconnection and desired path of travel, deflection, and/or rotation. The segments 212, 214 may also collectively form a staggered serpentine configuration. For example, the deformable segments 212 may be longer or shorter than the static segments 214, such that the ends of adjacent deformable segments 212 may be offset in a direction substantially parallel to longitudinal axes of the deformable segments 212.

Referring to FIG. 3 with continued reference to FIG. 1C, illustrated is a perspective view of a portion of another embodiment of an actuator 310 constructed according to aspects of the present disclosure. The actuator 310 may be substantially similar in composition and manufacture to the actuator 170 shown in FIG. 1C. The actuator 310 may be defined from the actuator layers 130, 150, and 160 of FIG. 1C, such as by etching or otherwise patterning. In the embodiment shown in FIG. 3, the actuator 310 has a substantially helical shape. That is, the actuator 310 includes laterally disposed segments 320, each of which may be considered a winding, or may employ 3 or 4 turns in current path.

A convenient convention in describing the layout or pattern of actuators herein is to trace current flow through the actuators. Thus, in the illustrated embodiment, current may propagate through an actuator segment 320 beginning from a portion 312 defined from the semiconductor layer 130, then through a portion 314 defined from one or both of the actuator layers 150 and 160, then back through another portion 316 defined from the actuator layer 130 in a physical direction opposite to the physical direction of current in the actuator portion 312, as shown by arrows in FIG. 3. A first end of the portion 314 is electrically coupled to the portion 312, and a second end of the portion 314 is electrically coupled to the portion 316, although a substantial length of the portion 314 is electrically isolated from the portion 316, such as by a portion of the sacrificial layer 140, which may become an air gap during manufacturing. The actuator 310 may comprise any number of segments 320, each of which may comprise portions 312, 314, 316. Moreover, the segments 320 may each be rectilinear, curvilinear, a combination thereof, or otherwise patterned as necessary for interconnection and desired path of travel, deflection, and/or rotation.

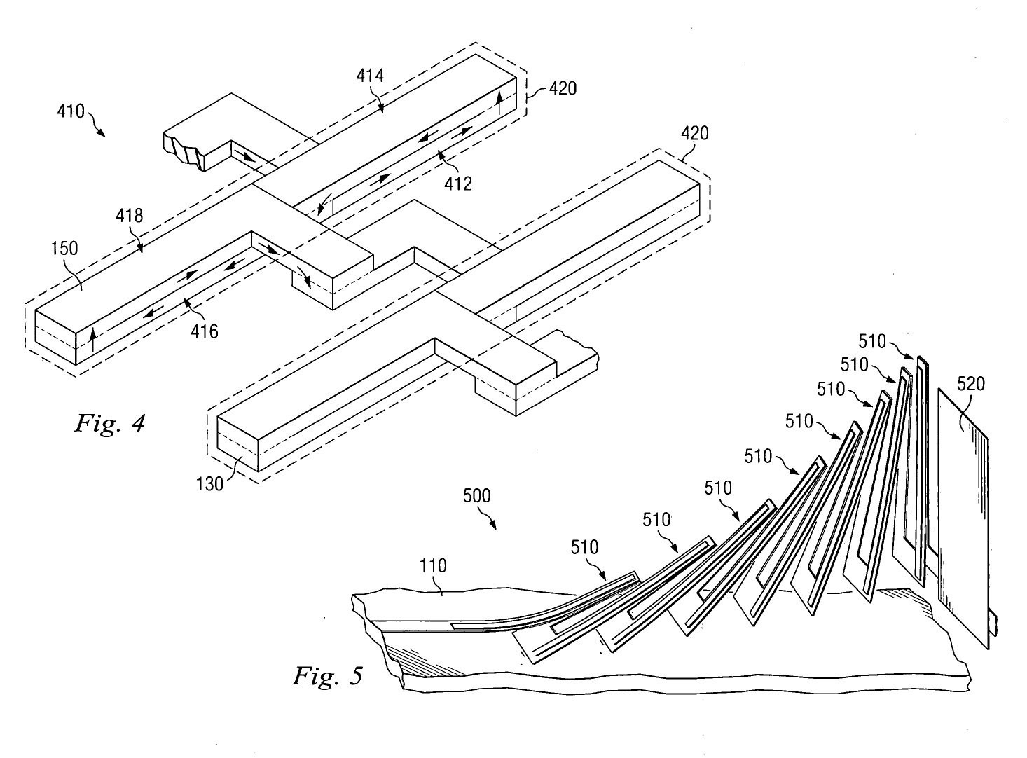

Referring to FIG. 4 with continued reference to FIG. 1C, illustrated is a perspective view of another embodiment of an actuator 410 constructed according to aspects of the present disclosure. The actuator 410 may be substantially similar in composition and manufacture to the actuator 170 shown in FIG. 1C. The actuator 410 may be defined from the actuator layers 130, 150, and 160 of FIG. 1, such as by etching or otherwise patterning, or from the actuator layers 130 and 150, as in the illustrated embodiment.

In the embodiment shown in FIG. 4, the actuator 410 includes segments 420 each having a substantially figure-8 shaped configuration. That is, each of the laterally disposed segments 420 include 4 portions forming a figure-8 shape. For example, current may propagate through an actuator segment 420 beginning from a portion 412 defined from the actuator layer 130, then through a portion 414 defined from one or both of the actuator layers 150 and 160, then through a portion 416 defined from the actuator layer 130, and then through a portion 418 defined from one or both of the actuator layers 150 and 160. A first end of the portion 414 is electrically coupled to the portion 412, and a second end of the portion 414 is electrically coupled to the portion 416, although a substantial length of the portion 414 is electrically isolated from the portion 412, such as by a portion of the sacrificial layer 140, an air gap, and/or an insulating material. Similarly, a first end of the portion 416 is electrically coupled to the portion 414, and a second end of the portion 416 is electrically coupled to the portion 418, although a substantial length of the portion 416 is electrically isolated from the portion 418. The actuator 410 may comprise any number of segments 420, each of which may comprise portions 412, 414, 416, 418. Moreover, the segments 420 may each be rectilinear, curvilinear, a combination thereof, or otherwise patterned as necessary for interconnection and desired path of travel, deflection, and/or rotation.

The actuators 210, 310, and 410 may be employed, separately or in combination, to form MEMS devices of various configurations. For example, referring to FIG. 5, illustrated is a perspective view of one embodiment of a MEMS device 500 constructed according to aspects of the present disclosure. The MEMS device 500 is illustrated in a deflected state, wherein exposure to thermal and/or electrical energy has caused actuator segments 510 to deflect. The deflection of the segments 510 has caused the translation and/or rotation of a payload 520 away from an as-built, pre-deflection state in which the segments 510 and the payload 520 may be substantially parallel to the substrate 110.

The MEMS device 500 may be classified as a helical, staggered, rectilinear, partially-metallized device. That is, the MEMS device 500 may be classified as helical because it employs actuator segments 510 that are substantially similar to the actuator segments 320 shown in FIG. 3. Ends of each or several of the segments 510 are offset from ends of adjacent segments 510 in a direction 520, such that the segments 510 are also staggered. The direction 520 is substantially parallel to longitudinal axes of the segments 510 in a pre-deflection state. The segments 510 are also patterned from actuator layers in substantially straight, non-curved, rectangular, or otherwise rectilinear (herein collectively referred to as rectilinear) segments. Moreover, only portions of the segments 510 include a metallic actuator layer (such as the actuator layer 160 discussed above), such that the MEMS device 500 is only partially metallized.

The payload 520 may be defined from one or both of the actuator layers 150 and 160 shown in FIG. 1C. Thus, the payload 520 may be integral to or otherwise coupled to opposing ones of the actuator segments 510. The payload 520 may comprise a mirrored surface and/or a grating surface, such as when the MEMS device 500 is employed as a switch and/or a filter in an optical system. The payload 520 may also comprise an electrically conductive plate or layer, such as when the MEMS device 500 is employed as a capacitive element or a portion thereof. The payload 520 may also comprise a spiral-shaped trace, such as when the MEMS device 500 is employed as an inductive element or a portion thereof.

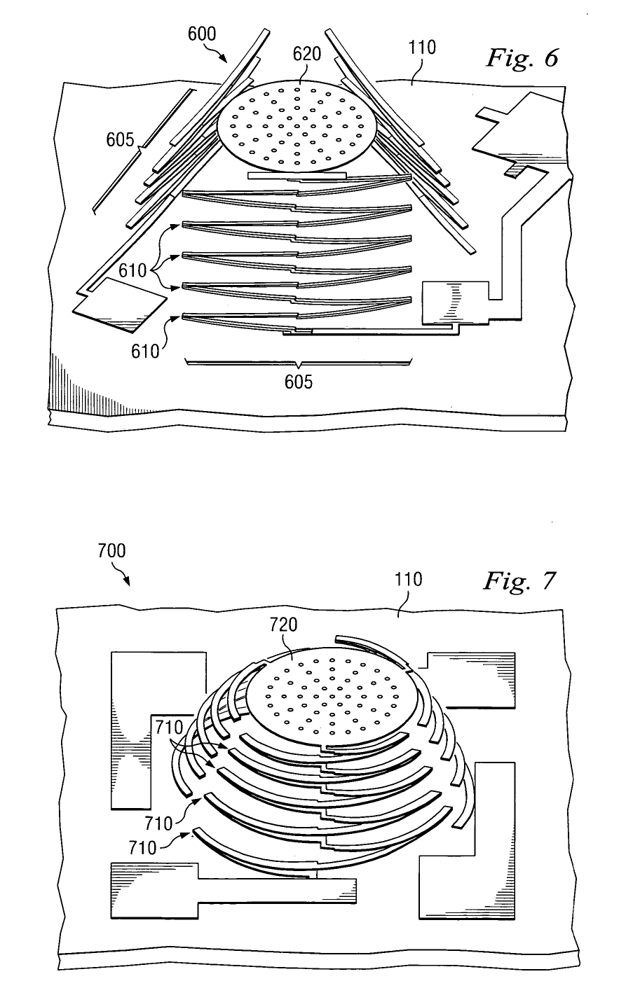

Referring to FIG. 6, illustrated is a perspective view of another embodiment of a MEMS device 600 constructed according to aspects of the present disclosure. The MEMS device 600 includes 3 groups 605 of actuator segments 610. The MEMS device 600 is illustrated in a deflected state, wherein exposure to thermal and/or electrical energy has caused actuator segments 610 to deflect. The deflection of the segments 610 has caused the translation of a payload 620 away from an as-built, pre-deflection state in which the segments 610 and the payload 620 are substantially parallel to the substrate 110.

The MEMS device 600 may be classified as a figure-8 shaped, symmetric, rectilinear, partially-metallized device. The MEMS device 600 may be classified as figure-8 shaped because it employs actuator segments 610 that are substantially similar to the actuator segments 420 shown in FIG. 4. Ends of each or several of the segments 610 are not offset from, or are substantially aligned with, ends of adjacent segments 610, such that the segments 610 are also symmetric. The segments 610 are also patterned from actuator layers in substantially rectilinear segments. Moreover, only portions of the segments 610 include a metallic actuator layer (such as the actuator layer 160 discussed above), such that the MEMS device 600 is only partially metallized.

Referring to FIG. 7, illustrated is a perspective view of one embodiment of a MEMS device 700 constructed according to aspects of the present disclosure. The MEMS device 700 includes 4 groups of actuator segments 710. The MEMS device 700 is illustrated in a deflected state, wherein exposure to thermal and/or electrical energy has caused actuator segments 710 to deflect. The deflection of the segments 710 has caused the translation of a payload 720 away from an as-built, pre-deflection state in which the segments 710 and the payload 720 are substantially parallel to the substrate 110.

The MEMS device 700 may be classified as a figure-8 shaped, symmetric, curvilinear, partially-metallized device. That is, the MEMS device 700 may be classified as figure-8 shaped because it employs actuator segments 710 that are substantially similar to the actuator segments 420 shown in FIG. 4. Ends of each or several of the segments 710 are not offset from, or are substantially aligned with, ends of adjacent segments 710, such that the segments 710 are also symmetric. The segments 710 are also patterned from actuator layers in substantially curvilinear segments, or arcs. Moreover, only portions of the segments 710 include a metallic actuator layer (such as the actuator layer 160 discussed above), such that the MEMS device 700 is only partially metallized.

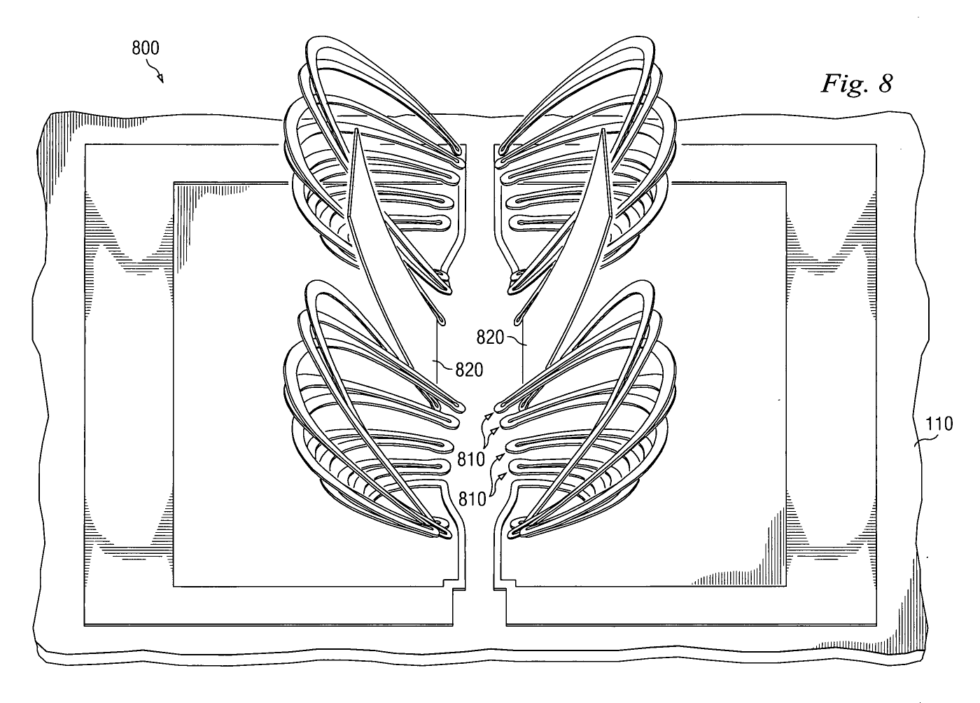

Referring to FIG. 8, illustrated is a perspective view of one embodiment of a MEMS device 800 constructed according to aspects of the present disclosure. The MEMS device 800 includes 4 groups of actuator segments 810 employed to simultaneously or independently actuate 2 payloads 820. The MEMS device 800 is illustrated in a deflected state, wherein exposure to thermal and/or electrical energy has caused actuator segments 810 to deflect. The deflection of the segments 810 has caused the rotation and/or translation of a payload 820 away from an as-built, pre-deflection state in which the segments 810 and the payload 820 are substantially parallel to the substrate 110.

The MEMS device 800 may be classified as a serpentine, symmetric, curvilinear, substantially-metallized device. That is, the MEMS device 800 may be classified as serpentine because it employs actuator segments 810 that are substantially similar to the actuator segments 220 shown in FIG. 2. Ends of each or several of the segments 810 are not offset from, or are substantially aligned with, ends of adjacent segments 810, such that the segments 810 are also symmetric. The segments 810 are also patterned from actuator layers in substantially curvilinear segments, or arcs. Moreover, substantial portions 6 f the segments 810 include a metallic actuator layer, such that the MEMS device 800 is substantially or completely metallized. The metallic actuator layer may be substantially similar in composition and manufacture to the actuator layer 160 shown in FIG. 1C. Moreover, each or several of the segments 810 may be substantially similar to the structure shown in FIG. 1C.

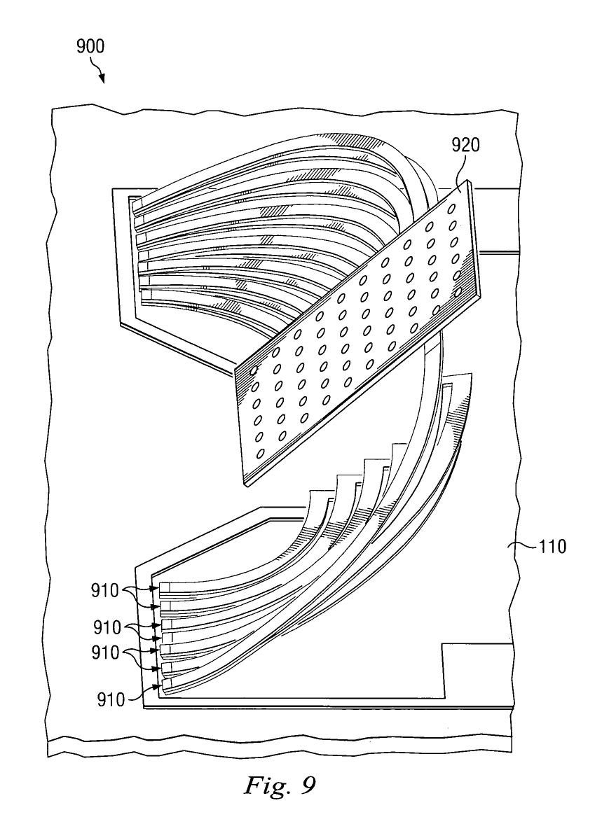

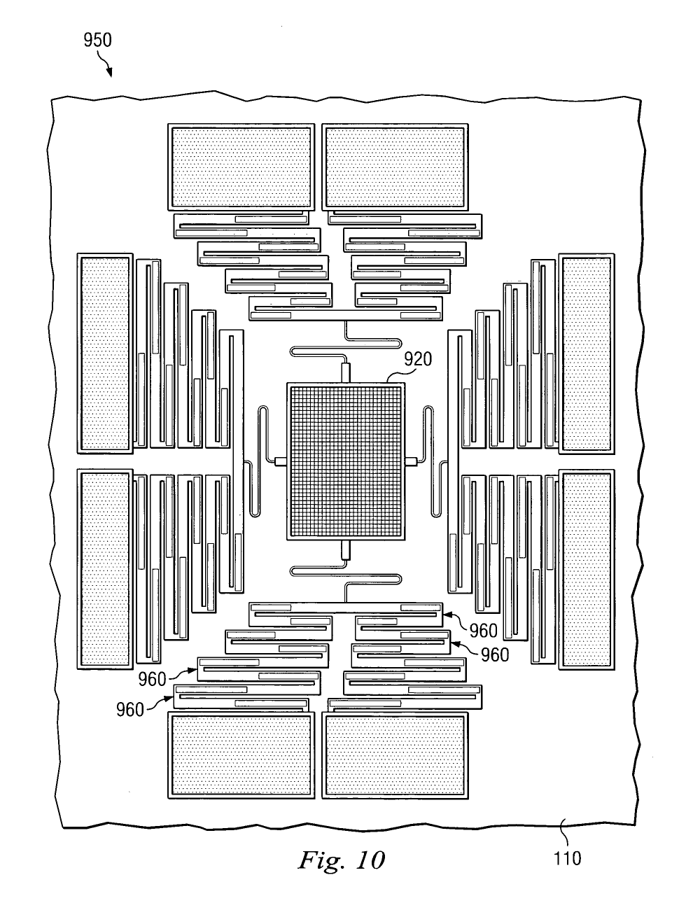

Referring to FIG. 9, illustrated is a perspective view of one embodiment of a MEMS device 900 constructed according to aspects of the present disclosure. The MEMS device 900 is illustrated in a deflected state, wherein exposure to thermal and/or electrical energy has caused actuator segments 910 to deflect. The deflection of the segments 910 has caused the rotation and/or translation of a payload 920 away from an as-built, pre-deflection state in which the segments 910 and the payload 920 are substantially parallel to the substrate 110.

The MEMS device 900 may be classified as a helical, symmetric, curvilinear, partially-metallized device. That is, the MEMS device 900 may be classified as helical because it employs actuator segments 910 that are substantially similar to the actuator segments 320 shown in FIG. 3. Ends of each or several of the segments 910 are not offset from, or are substantially aligned with, ends of adjacent segments 910, such that the segments 910 are also symmetric. The segments 910 are also patterned from actuator layers in substantially curvilinear segments, or arcs. Moreover, only portions of the segments 910 include a metallic actuator layer (such as the actuator layer 160 discussed above), such that the MEMS device 900 is only partially metallized.

Referring to FIG. 10, illustrated is a perspective view of one embodiment of a MEMS device 950 constructed according to aspects of the present disclosure. The MEMS device 950 includes 4 groups of actuator segments 960 employed to actuate a payload 970. The MEMS device 950 is illustrated in a deflected state, wherein exposure to thermal and/or electrical energy has caused actuator segments 960 to deflect. The deflection of the segments 960 has caused the translation of a payload 970 away from an as-built, pre-deflection state in which the segments 960 and the payload 970 are substantially parallel to the substrate 110.

The MEMS device 950 may be classified as a serpentine, symmetric, rectilinear, partially-metallized device. That is, the MEMS device 950 may be classified as serpentine because it employs actuator segments 960 that are substantially similar to the actuator segments 220 shown in FIG. 2. Ends of each or several of the segments 960 are not offset from, or are substantially aligned with, ends of adjacent segments 960, such that the segments 960 are also symmetric. The segments 960 are also patterned from actuator layers in substantially rectilinear segments. Moreover, only portions of the segments 960 include a metallic actuator layer (such as the actuator layer 160 discussed above), such that the MEMS device 950 is only partially metallized.

As previously mentioned, each of the devices 500, 600, 700, 800, 900, 950 described above may be deformed or otherwise actuated in response to exposure to thermal energy. Possible sources for such thermal energy may include a hot plate, a furnace, an oven, a laser and/or other sources. In one embodiment, a current source is coupled to contacts for delivering electrical current through the actuator segments. In such embodiments, the actuator segments and/or other portions of the MEMS devices may comprise material that is thermally resistive or dissipates heat in response to electrical current. Accordingly, the source of the deforming thermal energy may be the actuator segments themselves, such as through ohmic heating.

The exposure to thermal energy described above may be more severe than the thermal energy conventionally employed to actuate a typical bimorph MEMS actuator. Conventionally, a MEMS bimorph actuator is exposed to sufficient thermal energy to elastically deflect the actuator, such that when the thermal energy is removed the actuator returns to an as-built or as-released position. However, MEMS devices constructed according to aspects of the present disclosure may also be exposed to sufficient thermal energy to cause plastic deformation, such that when the plastically deforming thermal energy is removed the actuator segments maintain (or are deformed into) some degree of deflection.

For example, a MEMS device constructed according to aspects of the present disclosure may be exposed to 2 one-second electrical pulses at about 12 volts, such that the actuator segments may be plastically deformed to orient a payload in a position that is angularly offset about 45° relative to the substrate on which the MEMS device is formed. In another example, a MEMS device constructed according to aspects of the present disclosure may be exposed to 2 one-second electrical pulses at about 14 volts to sufficiently plastically deform it so as to orient a payload in a position that is angularly offset about 60° to about 65° relative to the substrate. Similarly, a MEMS device constructed according to aspects of the present disclosure may be exposed to a single, one-second electrical pulse at about 16 volts, such that a payload is oriented at about 90° relative to the substrate.

The deflection and/or deformation of a MEMS device constructed according to aspects of the present disclosure may be employed to configure the MEMS device to have a desired electrical characteristic in a biased and/or unbiased position. For example, the actuator segments thereof may be plastically deformed into a position that configures the MEMS device to exhibit a desired inductance, capacitance or other characteristic. The actuator segments may also be deformed into a position that configures a payload in a desired orientation, such as in embodiments in which the payload comprises a mirrored surface or a periodic structure. After plastic deformation, the actuator segments may be further actuated by exposure to thermal energy to elastically deflect the actuator segments to a biased position temporarily until the MEMS device is removed from the exposure to thermal energy. Such elastically deforming thermal energy may emanate from the same source employed during the plastic deformation, although possibly to a lesser degree.

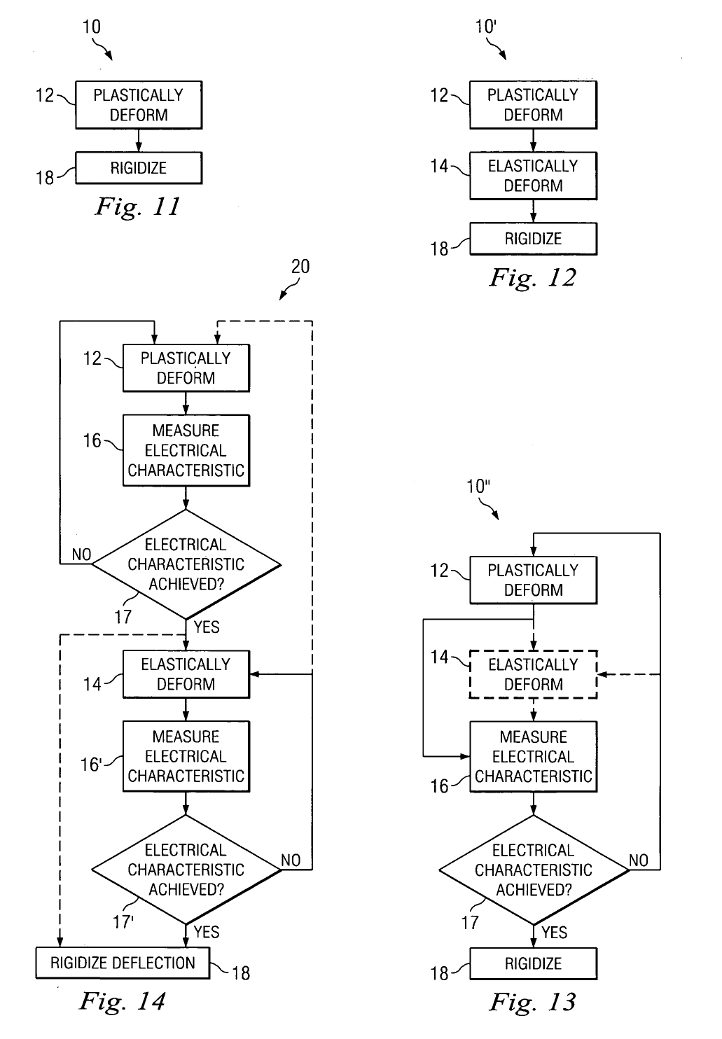

Referring to FIG. 11, illustrated is a block diagram of one embodiment of a method 10 of tuning a MEMS device according to aspects of the present disclosure. MEMS devices which may be tuned according to the method 10 include the MEMS devices 100, 500, 600, 700, 800, 900, and 950 described above, as well as other MEMS devices. These and other MEMS devices which may be tuned according to the method 10 may include RF devices such as filters, capacitors, inductors, couplers, etc. MEMS devices tunable by the method 10 may also comprise bimorph conductors, for example, as in embodiments discussed above.

The MEMS device may be tuned according to the method 10 to adjust a magnetic or electrical characteristic of the device. For example, executing the method 10 may adjust an upper and/or lower bound of a range of frequencies at which electrical signals may enter and/or exit the device, or otherwise propagate along the device. Such a device may consequently operate similar to a band-pass filter. Executing the method 10 may also adjust an upper bound and/or lower bound of a range of frequencies at which electrical signals do not enter and/or exit the device, or otherwise propagate along the device. Such a device may consequently operate similar to a notch filter. Tuning the device according to the method 10 may also adjust the impedance and/or quality factor of the device.

The method 10 includes a step 12 in which a MEMS actuator is plastically deformed. The actuator may be plastically deformed by exposing the actuator and/or the device to thermal energy. For example, the actuator may be heated by ohmic heating resulting from exposure to a voltage or current source. The actuator may alternatively or additionally be heated by exposure to a heat lamp, an oven, a laser, and/or other heat sources.

In one embodiment, tuning the device by plastically deforming the actuator may comprise exposing the actuator to a series of voltage pulses, wherein the number, length, and amplitude of the pulses may be selected to achieve a predetermined plastic deformation of the actuator. For example, the actuator may be fabricated in such a manner that the initial released position of the actuator may be substantially parallel to an underlying substrate, and a subsequently applied pulse (e.g., about 12 volts for a duration of about 1 second) may plastically deflect the actuator to a position that is angularly offset (e.g., by about 40 degrees) relative to the substrate. The devices 500 and 900 shown in FIGS. 5 and 9 provide examples of such tuning.

The voltage level and duration of the pulse may vary within the scope of the present disclosure. Moreover, a series of pulses may be employed to plastically deflect the actuator to a desired position and obtain a desired electrical, magnetic, and/or electromagnetic characteristic. For example, the following table provides one embodiment in which a series of pulses may be applied, such as to the devices 500 and 900 shown in FIGS. 5 and 9 (among others), to achieve a plastic deformation of about 90 degrees relative to the substrate.

| Pulse Number | Voltage (volts) | Duration (seconds) | Angle (degrees) |
|---|---|---|---|
| 1 | 12 | 1 | ˜40 |
| 2 | 12 | 1 | ˜45 |
| 3 | 14 | 1 | ˜60 |
| 4 | 14 | 1 | ˜65 |
| 5 | 16 | 1 | ˜90 |

After the actuator or device has been plastically deformed, another electrical signal may be operate the device, such as to elastically deform the actuator. Such elastic operation may be achieved by lower voltage levels than those employed during plastic deformation, including via a sinusoidal or other shaped periodic or regular signal, possibly having a voltage level of about 9 volts or less.

The actuator or other portion of the device being tuned may be designed in a given fabrication process such that the actuator may deflect toward and/or against the substrate, or away from the desired final deflection, in response to the plastically deforming pulse or signal. Consequently, when the plastically deforming signal is removed, the released actuator may move away from the substrate past its fabricated position. That is, the actuator may be biased to press against the substrate such that, upon release of or removal from the biasing source, the actuator deflects away from the substrate to an angular or substantially planar offset relative to the substrate, as shown in FIGS. 5-9. This may be achieved by forming the actuator as a bimorph actuator having first and second layers sequentially formed over and subsequently released from a substrate, wherein the first layer (between the substrate and the second layer) has a higher coefficient of thermal expansion than the coefficient of thermal expansion of the second layer, possibly as described in embodiments discussed above.

The method 10 may also include a step 18 in which the plastic deformation attained in the step 12 may be rigidized. That is, the device may be tuned during the step 12 by plastic deformation to achieve a desired electrical or magnetic characteristic of the device, and this desired characteristic may be maintained by securing the deformed position of the actuator. For example, an epoxy or other encapsulant may be formed and cured or otherwise hardened around the deformed actuator. In one embodiment, the epoxy is a UV-curable epoxy. The epoxy or other encapsulant may also be optically transparent, such as in embodiments in which the payload of the actuator or device is a mirror or other optical signal deflector or modifier. However, in some embodiments in which it may desired to further elastically and/or plastically deform the actuator or device, the rigidization of step 18 may not be performed.

Referring to FIG. 12, illustrated is a block diagram of another embodiment of the method 10 shown in FIG. 11, herein designated by the reference symbol 10 ′. The method 10 ′ is substantially similar to the method 10 described above. However, the method 10 ′ includes an additional step 14 in which the actuator or other portion of the device is elastically deformed after the plastic deformation of step 12. Of course, in other embodiments, the elastic deformation of step 14 may be performed prior to the plastic deformation of step 12. Tuning methods according to aspects of the present disclosure may also include multiple segregated or intermingled elastic and/or plastic deformation steps.

In one embodiment, the plastic deformation of step 12 may be performed to coarsely tune the device, and the elastic deformation of step 14 may be performed to finely tune the device. The elastic deformation of step 14 and the rigidization of step 18 may also be combined or performed concurrently, such that the elastic deformation may be maintained while the actuator is secured in a desired position.

Referring to FIG. 13, illustrated is a block diagram of another embodiment of the method 10 shown in FIG. 11, herein designated by the reference symbol 10″. The method 10″ is substantially similar to the method 10 described above. However, the method 10″ includes an additional step 16 in which the electrical characteristic being tuned is measured. Any conventional or future-developed measurement method may be employed in step 16 to measure the electrical characteristic of the device. For example, an LCR (L: inductance; C: capacitance; R: resistance) meter or a vector network analyzer (VNA) may be employed to measure the electrical characteristic.

The method 10″ also includes a decisional step 17 in which the measured value determined in step 16 is compared to a desired value. If the desired electrical characteristic has been attained, subsequent steps in the method 10″ may be performed, such as step 18, if desired. However, if it is determined in step 17 that the desired electrical characteristic has not yet been attained, the plastic deformation step 12 may be repeated. Parameters of the subsequent plastic deformation may be based on, depend on, and/or be calculated using the difference between the measured electrical characteristic and the desired characteristic. Moreover, this calculation may be performed automatically, possibly requiring no user interaction.

As also shown in FIG. 13, the method 10″ may also include the elastic deformation of step 16 described above. In such an embodiment, if it is determined in the decisional step 17 that the desired electrical characteristic has not yet been attained, the elastic deformation of step 16 may be repeated, either in addition to or as an alternative to the plastic deformation of step 14. As with the subsequent plastic deformation parameters, parameters of the subsequent elastic deformation may be calculated using the difference between the measured electrical characteristic and the desired characteristic, possibly requiring no user interaction.

Referring to FIG. 14, illustrated is a block diagram of another embodiment of the method 10″ shown in FIG. 13, herein designated by the reference numeral 20. The method 20 is substantially similar to the method 10″ shown in FIG. 13. However, the method 20 includes multiple measurement steps 16 and decisional steps 17.

According to aspects of the method 20, the electrical characteristic being tuned is measured in a first step 16 after the plastic deformation of step 12 is performed. If the electrical characteristic has been attained, or if at least coarse tuning has been achieved, as determined in the decisional step 17, the elastic deformation of step 14 may be initiated or the device may be rigidized in step 18. However, if the plastic deformation of step 12 has not been sufficient, additional plastic deformation may be performed by repeating step 12.

The method 20 also includes a second measurement step 16′ performed after the elastic deformation of step 14 is performed. The measurement step 16′ may be substantially similar to the measurement step 16. The method 20 also includes a second decisional step 17′ which may be substantially similar to the decisional step 17. If it is determined in the decisional step 17′ that the desired electrical characteristic has been attained, or that fine tuning has been achieved, the device may be rigidized in step 18. However, if the electrical characteristic has not been attained, as determined by the decisional step 17′, the elastic deformation of step 14 may be repeated. In one embodiment, a determination in decisional step 17′ that the electrical characteristic has not yet been attained may also result in the repeat of the plastic deformation of step 12, in addition to or in the alternative to repeating the elastic deformation step 14. Thus, a series of plastic deformations and/or elastic deformations may be repeated until the desired electrical characteristic is achieved.

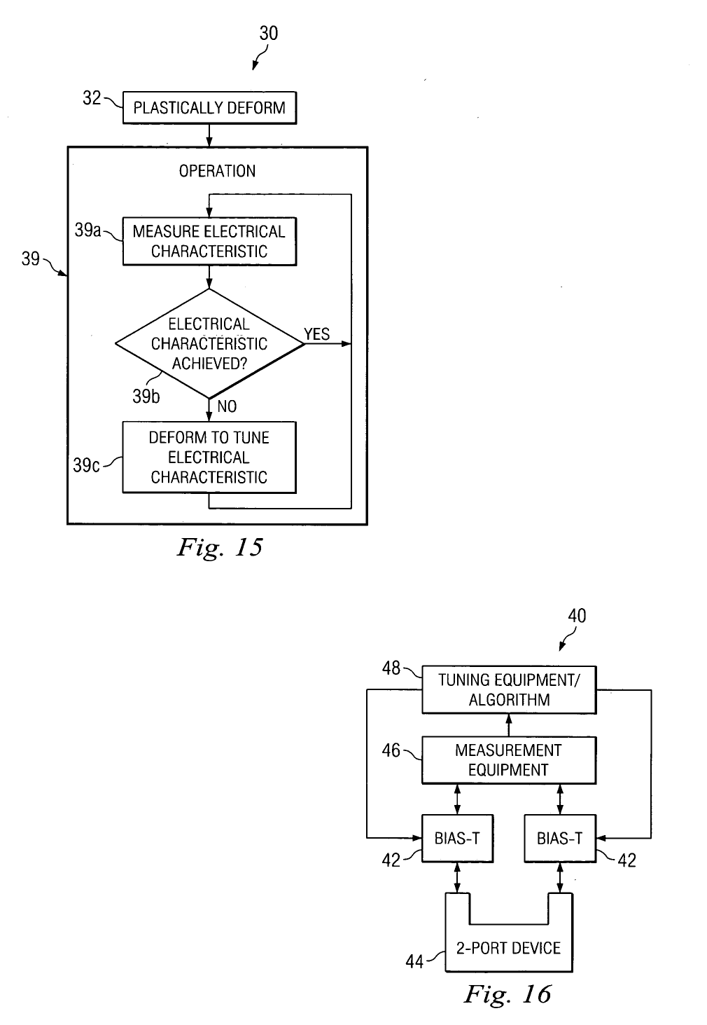

Referring to FIG. 15, illustrated is a block diagram of another method 30 of tuning a device according to aspects of the present disclosure. The method 30 may be performed to actively tune the device after fabrication is substantially complete, including during operation of the device.

The method 30 includes a plastic deformation step 32 which may be substantially similar to the plastic deformation step 12 of method 10 shown in FIG. 11. After the device is plastically deformed in step 32, operation 39 may initiate. However, in other embodiments, additional deformation and/or measurement steps may be performed between the plastic deformation step 32 and the operation 39, including those of methods 10′, 10″, and 20 described above.

Maintaining the status of the electrical characteristic tuned in the deformation step 32 may be crucial to optimum performance of the device during its operation 39. Thus, the electrical characteristic may be retuned during operation 39. Moreover, in some embodiments, changes in the operating environment may result in adjusting the desired level of the tuned electrical characteristic, such that electrical characteristic may be retuned even if it has not strayed from its initially tuned status.

Accordingly, the operation 39 includes a measurement step 39a in which the electrical characteristic is measured. The measurement step 39a may be substantially similar to the measurement step 16 shown in FIG. 13. The operation 39 also includes a decisional step 39b in which the results of the measurement step 39a are compared to a desired electrical characteristic. The decisional step 39b may be substantially similar to the decisional step 17 shown in FIG. 13. If it is determined in the decisional step 39b that the electrical characteristic is at the desired level or otherwise does not require retuning, measurement of the electrical characteristic may resume in the measurement step 39a.

However, if it is determined in the decisional step 39b that retuning is required, an actuator or other portion of the operating device may be plastically or elastically deformed in a step 39c. The deformation in step 39c may be substantially similar to the deformation of steps 12 and 14 described above. In one embodiment, the deformation of step 39c comprises multiple elastic and/or plastic deformation steps.

After the deformation of step 39c is performed to retune the device, thereby adjusting the electrical characteristic to a previous or new desired level, measurement of the electrical characteristic may resume in the measurement step 39a. The steps 39a-c may thus be repeated as necessary, possibly throughout the operation 39 of the device. However, in one embodiment, one or more iterations of the steps 39a-c may be repeated after certain operating device events, such as power-up, hand-off, establishment of a communication link, etc., and otherwise remain dormant until another such event occurs.

Referring to FIG. 16, illustrated is a schematic of one embodiment of a circuit 40 implementing the method 30 shown in FIG. 15. The circuit 40 may include two bias-T components 42 for providing simultaneous RF and DC interface with a two-port device 44 being tested/operated. The bias-T components 42 may be conventional and/or future-developed devices, and may be configured to insert or extract simultaneous RF and DC signals to the device 44. For example, the bias-T components 42 may each include a DC source and/or sensor coupled via an inductive element to a port of the component 44 in parallel with an RF source and/or sensor coupled via a capacitive element to the port.

An example of the two-port device 44 is described below. However, in general, the device 44 is any device having two ports (e.g., an input and an output), including but not limited to an amplifier, a filter, an attenuator, and a coupler. Moreover, the scope of the present disclosure is not limited to two-port devices. For example, aspects of the present disclosure are applicable and/or readily adaptable to one-port devices and N-port devices and circuits, wherein N is an integer greater than 2.

The circuit 40 also includes measurement equipment 46 for detecting an RF and/or DC response of the device 44. Examples of the measurement equipment 46 include, but are not limited to, LCR meters and VNAs.

The circuit 40 also includes tuning equipment 48 coupled to the measurement equipment 46. The tuning equipment 48 is configured to receive measured data from the measurement equipment 46 and alter the DC and/or RF signal applied to the device 44 via the bias-T components 42.

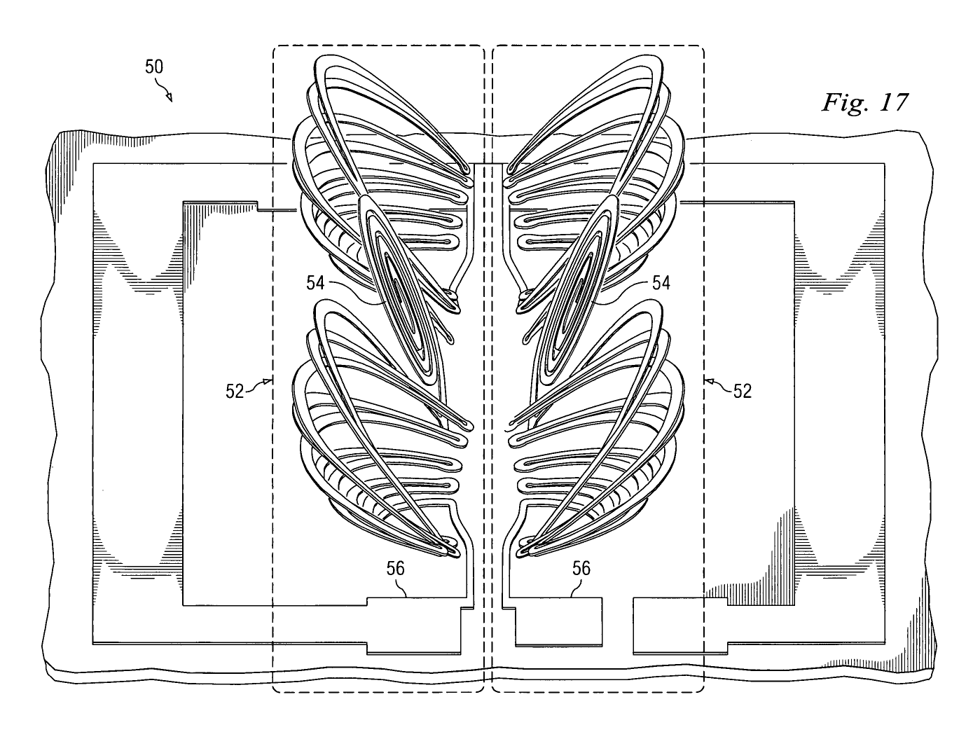

Referring to FIG. 17, illustrated is a perspective of one embodiment of a tunable device 50 that may be employed with embodiments of the circuit 40 shown in FIG. 16, and that may be tuned by the methods 10, 10′, 10″, and 20 described above. Thus, in one embodiment, the device 50 may be employed as an RF coupler.

The device 50 includes two actuators 52 each having a central coiled section 54. The device 50 may be tuned employing plastic and/or elastic deformation to adjust the separation between the coiled sections 54. The actuators 52, or portions thereof, comprise bimorph sections including two layers having different coefficients of thermal expansion. The device 50 also includes at least 2 ports 56 for coupling the device 50 to a tuning circuit, such as the circuit 40 shown in FIG. 16. By coupling the device 50 to a tuning circuit having RF and DC capabilities, the RF response of the device 50 may be measured and, possibly simultaneously, adjusted by applying a DC bias to plastically and/or elastically deform the actuators 52, thereby actively tuning the device 50.

Aspects of the device 50 may also be applicable or readily adaptable to other RF applications. For example, the coiled sections 54 of the actuators 52 may be coupled to or replaced by capacitive plates, such that tuning the device 50 may adjust the capacitive coupling of the device 50 in addition to or in the alternative to adjusting the inductive coupling.

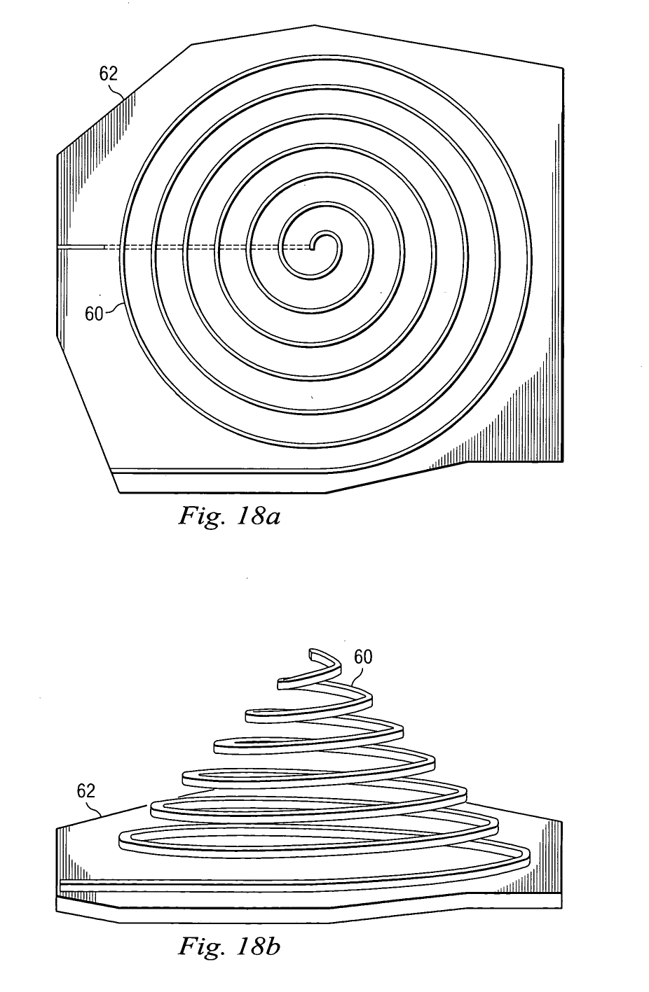

Referring to FIG. 18a, illustrated is a top view of a spiral conductor 60 which may be employed as an inductive device in myriad circuits. However, by forming the spiral conductor 60 with bimorph materials, the conductor 60 may be deformed into a conical or other 3-dimensional shape, as shown in FIG. 18b. Consequently, the inductance and/or quality factor attainable with the conductor 60 may be increased. That is, the inductance and/or quality factor of the conductor 60 may be increased by increasing the volume occupied by the resulting inductor's electromagnetic field, thereby increasing energy storage capability. The inductance and/or quality factor may also increase as a result of moving a portion of the conductor 60 and the resulting electromagnetic field away from the substrate 62, thereby reducing substrate losses.

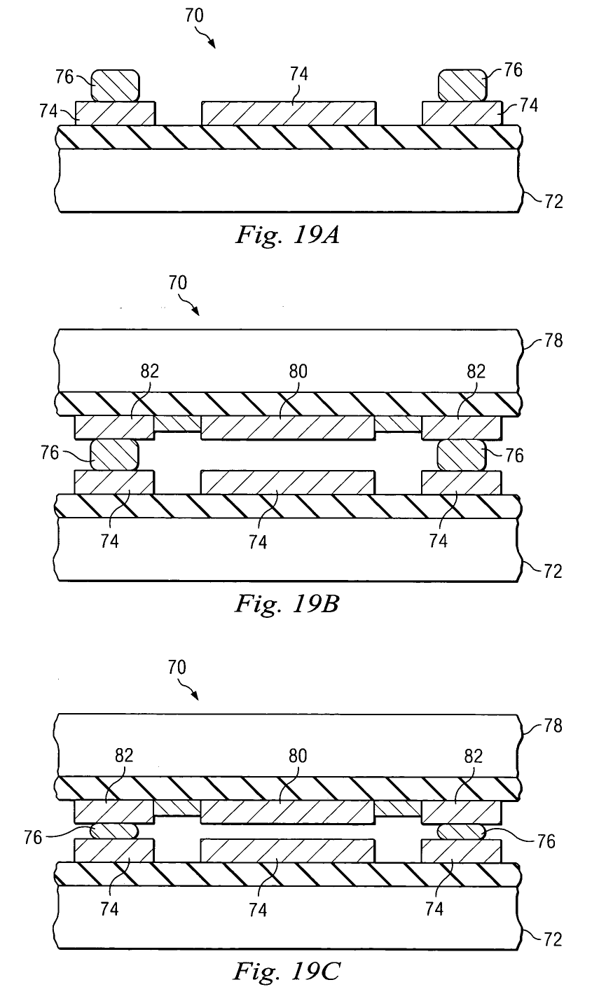

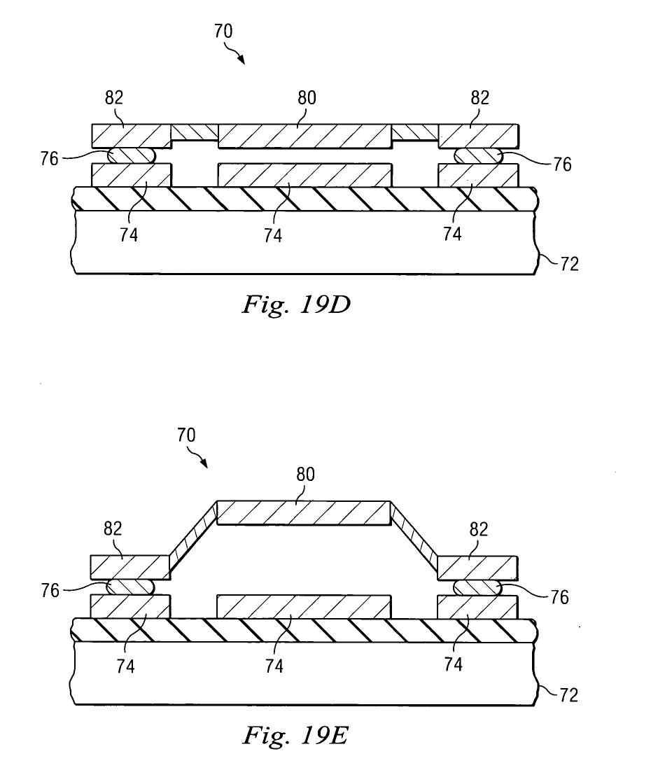

Referring to FIG. 19A, illustrated is a sectional view of an embodiment of a microelectronic device 70 in an intermediate stage of manufacture according to aspects of the present disclosure. The device 70 is one environment in which the conductor 60 of FIG. 18b and other 3-dimensional, plastically deformed devices according to aspects of the present disclosure may be implemented. Moreover, the device 70 may be tuned by the methods 10, 10′, 10″, and 20 described above.

The microelectronic device 70 includes a device substrate 72 having traces, bond pads, and other conductors 74 formed thereon. The traces and bond pads 74 may comprise gold and/or other conductive materials. The device 70 also includes conductive bumps or balls 76 comprising solder, indium, and/or other materials. The bumps 76 are configured to mechanically and electrically couple subsequently provided components to the substrate 72 and/or the conductors 74.

Referring to FIG. 19B, illustrated is a sectional view of the device 70 shown in FIG. 19A in a subsequent stage of manufacture in which a dummy substrate 78 is oriented over the device substrate 72. The dummy substrate 78 includes a conductor 80 formed thereon. The conductor 80 is or comprises a bimorph actuator configured to be deflected toward or away from the device substrate 72, wherein such deflection may be adjustable such that a desired magnetic or electrical characteristic of the conductor 80 may be tuned. The dummy substrate 78 also includes bond pads 82 electrically coupled to the conductor and substantially aligned with the bumps 76 for mechanically and electrically coupling the conductor to the conductors 74. In one embodiment, the conductor 80 is substantially similar to the conductor 60 of FIG. 18b. The conductor 80 may also or alternatively be substantially similar to one or more of the other actuators described herein.

Referring to FIG. 19C, illustrated is a sectional view of the device 70 shown in FIG. 19B in a subsequent stage of manufacture in which the dummy substrate 78 is bonded to the device substrate 72 via the bumps 76. The bumps 76 may be mechanically thermally, sonically, thermo-sonically, or otherwise “activated” to mechanically and electrically couple the bond pads 74 and the bond pads 82. For example, a clamping force may be applied to clamp the substrates 72, 78 together, and/or the bumps 76 may be exposed to a thermosonic source.

Referring to FIG. 19D, illustrated is a sectional view of the device 70 shown in FIG. 19C in a subsequent stage of manufacture in which the conductor 80 and bond pads 82 are released from the dummy substrate 78 and the dummy substrate 78 is removed. The conductor 80 and bond pads 82 may be released from the dummy substrate 78 by a chemical etching possibly employing an HF composition and a de-ionized water rinse.

Referring to FIG. 19E, illustrated is a sectional view of the device 70 shown in FIG. 19D in a subsequent stage of manufacture in which the conductor 80 is plastically deformed and, thereby, further offset from the device substrate 72. The particular offset of the conductor 80 from the device substrate 72 may be achieved by predetermined deformation parameters, and/or by tuning according to the methods described above. The deformed conductor 80 may subsequently be elastically deformed, such as for active tuning of the device 70. Moreover, although not illustrated, an epoxy or other encapsulant may be formed around the deformed conductor 80 after tuning.

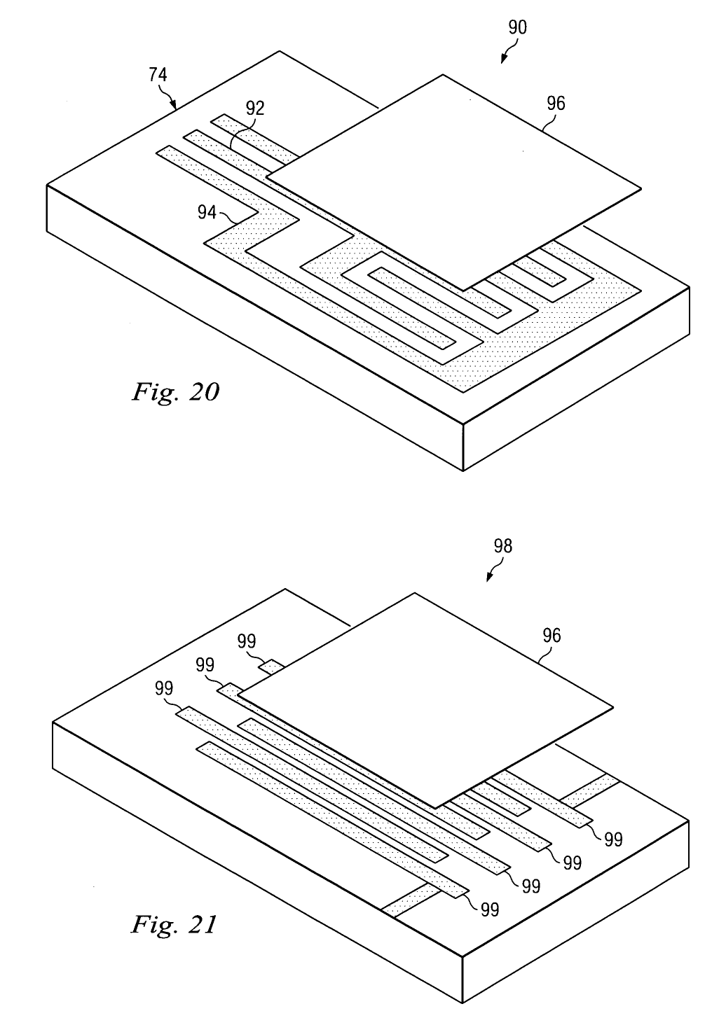

Referring to FIG. 20, illustrated is a perspective view of another embodiment of the device 70 shown in FIG. 19E, herein designated by the reference numeral 90. The traces 74 formed on the device substrate 72 include a central conductor 92 and an outer conductor 94, wherein the conductors 92, 94 include interdigitated fingers. The deformed conductor 80 in the present example may be, include, or be coupled to a capacitor plate 96. The offset between the plate 96 and the conductors 92, 94 is adjustable by plastically and/or elastically deforming the actuator portions of the conductor 80 suspending the plate 96 over the conductors 92, 94. These deformable portions of the conductor 80, while not shown in FIG. 20, may be substantially similar to one or more of the bimorph actuators described above. Accordingly, the capacitance of the device 90 may be tuned or adjusted according to the tuning methods described above. For example, increasing the distance between the capacitor plate 96 and the conductors 92, 94 by plastic and/or elastic deformation may decrease the capacitance of the device 90.

Referring to FIG. 21, illustrated is a perspective view of another embodiment of the device 90 shown in FIG. 20, herein designated by the reference numeral 98. The traces 74 of the device 98, herein designated by the reference numeral 99, include a series of substantially aligned or staggered conductors of similar or varying lengths. Accordingly, the traces 99 may be resonators in embodiments in which the device 90 is employed as a comb-line filter. By adjusting the distance separating the capacitor plate 96 from the traces 99, the coupling between the resonators may be adjusted, thereby tuning the device 98.

Thus, the present disclosure provides a MEMS device including a plurality of actuator layers formed over a substrate and a bimorph actuator having a substantially serpentine pattern. The serpentine pattern is a staggered pattern having a plurality of static segments interlaced with a plurality of deformable segments. Each of the plurality of static segments has a static segment length and each of the plurality of deformable segments has a deformable segment length, wherein the deformable segment length is substantially different than the static segment length. At least a portion of each of the plurality of deformable segments and each of the plurality of static segments is defined from a common one of the plurality of actuator layers.

Another embodiment of a MEMS device constructed according to aspects of the present disclosure includes a plurality of actuator layers formed over a substrate and a bimorph actuator. The bimorph actuator includes a plurality of segments defined from the plurality of actuator layers, wherein each of the plurality of segments includes a number of turns and is laterally offset from neighboring ones of the plurality of segments, the plurality of segments thereby forming a helical configuration.

Another embodiment of a MEMS device constructed according to aspects of the present disclosure includes a plurality of actuator layers formed over a substrate and a bimorph actuator. The bimorph actuator includes a plurality of segments defined from the plurality of actuator layers, wherein each of the plurality of segments has a substantially figure-8 shaped configuration.

The present disclosure also introduces a method of manufacturing an RF device including, in one embodiment, forming a deformable conductor over a substrate and plastically deforming the conductor via exposure to thermal energy to tune an electrical characteristic of the RF device. In another embodiment, the deformable conductor may also be elastically deformed to tuned the electrical characteristic.

A microelectronic RF device is also provided in the present disclosure. In one embodiment, the device includes a substrate and a plastically deformable bimorph actuator anchored to the substrate. The actuator is plastically deformed away from an as-built orientation relative to the substrate, such that the microelectronic RF device has a tuned electrical characteristic.

The foregoing has outlined features of several embodiments according to aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions and alterations herein without departing from the spirit and scope of the present disclosure.

1. A method of manufacturing an RF device, comprising:
forming a deformable conductor over a substrate; and
plastically deforming the conductor via exposure to thermal energy to tune an electrical characteristic of the RF device.

2. The method of claim 1 wherein the RF device is an RF filter.

3. The method of claim 2 wherein the electrical characteristic is one of an upper bound and a lower bound of a range of frequencies at which electrical signals propagate along the conductor.

4. The method of claim 2 wherein the electrical characteristic is one of an upper bound and a lower bound of a range of frequencies at which electrical signals can not propagate along the conductor.

5. The method of claim 1 wherein the RF device is an RF capacitor.

6. The method of claim 1 wherein the RF device is an RF inductor.

7. The method of claim 1 wherein the RF device is an RF coupler.

8. The method of claim 1 wherein the RF device is a one-port device.

9. The method of claim 1 wherein the RF devices is a two-port device.

10. The method of claim 1 wherein the RF device is an N-port device, wherein N is an integer greater than 2.

11. The method of claim 1 wherein the deformable conductor is a bimorph conductor.

12. The method of claim 1 wherein the thermal energy derives at least partially from ohmic heating.

13. The method of claim 1 wherein the thermal energy derives at least partially from a heat lamp.

14. The method of claim 1 wherein the thermal energy derives at least partially from an oven.

15. The method of claim 1 wherein the thermal energy derives at least partially from a laser.

16. The method of claim 1 wherein forming the conductor over the substrate includes:
forming an electrically insulating layer over the substrate;
forming a first conductive layer over the substrate;
forming a second conductive layer over the first conductive layer; and
patterning the first and second conductive layers to form the conductor.

17. The method of claim 16 wherein the first conductive layer comprises a first material having a first coefficient of thermal expansion and the second conductive layer comprises a second material having a second coefficient of thermal expansion, wherein the first and second coefficients of thermal expansion are substantially different.

18. The method of claim 16 further comprising forming a third conductive layer over the second conductive layer, wherein the third conductive layer is patterned with the first and second conductive layers to form the conductor.

19. The method of claim 1 wherein forming the conductor over the substrate includes forming the conductor as substantially parallel to the substrate, and wherein plastically deforming the conductor deforms the conductor to a position that is substantially non-parallel to the substrate.

20. The method of claim 1 wherein forming the conductor over the substrate includes forming the conductor at a first angle relative to the substrate, and wherein plastically deforming the conductor deforms the conductor to a second angle relative to substrate, wherein the first and second angles are substantially different.

21. The method of claim 20 wherein the first angle is substantially less than the second angle.

22. The method of claim 20 wherein the extent to which the first and second angles differ depends on a duration of the thermal energy exposure.

23. The method of claim 1 further comprising encapsulating the conductor after plastically deforming the conductor.

24. The method of claim 1 wherein plastically deforming the conductor via exposure to thermal energy comprises iteratively:
plastically deforming the conductor; and
measuring the electrical characteristic to determine if additional plastic deformation is required to complete tuning of the electrical characteristic.

25. The method of claim 1 wherein the plastic deformation coarsely tunes the electrical characteristic.

26. The method of claim 1 wherein the plastic deformation finely tunes the electrical characteristic.

27. The method of claim 1 wherein the RF device is an inductive device and exhibits a quality factor Q ranging between about 30 and about 300.

28. The method of claim 1 wherein the deformable conductor has a substantially serpentine pattern.

29. The method of claim 28 wherein the substantially serpentine pattern is a staggered serpentine pattern.

30. The method of claim 1 wherein the deformable conductor has a substantially rectilinear pattern.

31. The method of claim 1 wherein the deformable conductor has a substantially curvilinear pattern.

32. The method of claim 1 wherein the conductor includes a plurality of segments each including a number of turns and laterally offset from neighboring ones of the plurality of segments, the plurality of segments thereby forming a helical configuration.

33. The method of claim 1 wherein the conductor includes a plurality of segments having substantially similar lengths.

34. The method of claim 1 wherein the conductor is coupled to a payload and the electrical characteristic is tuned by adjusting an orientation of the payload relative to the substrate via the plastic deformation of the conductor.

35. The method of claim 34 wherein the substrate includes a plurality of interdigitated traces formed thereon proximate the payload.

36. The method of claim 34 wherein the RF device is an RF MEMS device.

37. A method of manufacturing an RF device, comprising:
forming a deformable conductor over a substrate;
plastically deforming the conductor via exposure to thermal energy to coarsely tune an electrical characteristic of the RF device; and
elastically deforming the conductor via exposure to thermal energy to finely tune the electrical characteristic.

38. The method of claim 37 further comprising forming an encapsulant around at least a portion of the conductor.

39. The method of claim 37 further comprising:
forming an encapsulant around a portion of the conductor prior to elastically deforming the conductor; and
curing the encapsulant after elastically deforming the conductor.

40. The method of claim 37 further comprising:
forming an encapsulant around a portion of the conductor after elastically deforming the conductor and while maintaining the elastic deformation of the conductor; and
curing the encapsulant to rigidize the elastic deformation of the conductor.

41. The method of claim 37 wherein elastically deforming the conductor to finely tune the electrical characteristic comprises iteratively:
elastically deforming the conductor via exposure to an initial level of thermal energy; and
measuring the electrical characteristic to determine if additional elastic deformation is required to complete tuning of the electrical characteristic;
elastically deforming the conductor via exposure to a subsequent level of thermal energy based on the electrical characteristic measurement; and
repeating iteratively the electrical characteristic measuring and the elastically deforming via exposure to subsequent levels of thermal energy as needed to tune the electrical characteristic.

42. The method of claim 37 wherein elastically deforming the conductor includes:
measuring the electrical characteristic;
determining a difference between the measured value of the electrical characteristic and a desired value;
elastically deforming the conductor by exposure to thermal energy based on the determined difference; and
rigidizing the conductor in the first position.

43. The method of claim 37 wherein elastically deforming the conductor includes measuring the electrical characteristic and employing the measured value as feedback to finely tune the electrical characteristic.

44. A microelectronic RF device, comprising:
a substrate;
a plastically deformable bimorph actuator anchored to the substrate, wherein the actuator is plastically deformed away from an as-built orientation relative to the substrate, the microelectronic RF device thereby having a tuned electrical characteristic.

45. The device of claim 44 wherein the plastic deformation of the actuator further provides the microelectronic RF device with a tuned electromagnetic characteristic.

46. The device of claim 44 wherein the actuator is also elastically deformed to further tune the electrical characteristic.

47. The device of claim 44 wherein the device is an RF filter.

48. The device of claim 44 wherein the microelectronic RF device is a band-pass filter and the tuned electrical characteristic is an operating range at which frequencies pass.

49. The device of claim 44 wherein the microelectronic RF device is a notch filter and the tuned electrical characteristic is an operating range at which frequencies do not pass.

50. The device of claim 44 wherein the microelectronic RF device is an RF capacitor.

51. The device of claim 44 wherein the microelectronic RF device is an RF inductor.

52. The device of claim 44 wherein the microelectronic RF device is an RF coupler.

53. The device of claim 44 wherein the RF device is a one-port device.

54. The device of claim 44 wherein the RF devices is a two-port device.

55. The device of claim 44 wherein the RF device is an N-port circuit, wherein N is an integer greater than 2.

56. The device of claim 44 further comprising an encapsulant rigidizing the actuator in the deformed orientation.

57. The device of claim 44 wherein the actuator has a substantially serpentine pattern.

58. The device of claim 57 wherein the substantially serpentine pattern is a staggered serpentine pattern.

59. The device of claim 44 wherein the actuator has a substantially rectilinear pattern.

60. The device of claim 44 wherein the actuator has a substantially curvilinear pattern.

61. The device of claim 44 wherein the actuator includes a plurality of segments each including a number of turns and laterally offset from neighboring ones of the plurality of segments, the plurality of segments thereby forming a helical configuration.

62. The device of claim 44 wherein the actuator includes a plurality of segments having substantially similar lengths.

63. The device of claim 44 wherein the actuator is coupled to a payload and the electrical characteristic is tuned according to the orientation of the payload relative to the substrate.

64. The device of claim 63 wherein the substrate includes a plurality of interdigitated traces formed thereon proximate the payload.

65. The device of claim 44 further comprising first and second ports electrically coupled to first and second bias-T components, respectively, wherein each of the first and second bias-T components are electrically coupled to means for measuring the electrical characteristic and to means for biasing the actuator to adjust the electrical characteristic.

66. The device of claim 44 wherein the actuator comprises first and second actuators plastically deformed toward each other from an as-built orientation.

67. The device of claim 66 wherein the first and second actuators are coupled to first and second payload coils, respectively, wherein the device is a tuned RF coupler.

68. The device of claim 66 wherein the first and second actuators each include first and second nested circular actuator segments.

69. The device of claim 44 wherein the actuator has a substantially cone-shaped and spiral 3-dimensional shape.

70. The device of claim 44 wherein the actuator is suspended over the substrate by stud bumps.

71. The device of claim 44 wherein the RF device is an RF MEMS device.
